(19) United States
(12) Patent Application Publication
(10) Pub. No.: US 2018/0157337 A1
(43) Pub. Date: Jun. 7, 2018

(54) CHINESE AND JAPANESE KANA INTEGRATED INPUT METHOD AND INPUT METHOD SYSTEM

(71) Applicant: Lianhui ZHOU, (US)

(72) Inventor: Lianhui ZHOU, Zhangjiagang, Jiangsu (CN)

(21) Appl. No.: 15/735,169

(22) PCT Filed: Jun. 15, 2015
(86) PCT No.: PCT/CN2015/000415

§ 371 Date: Dec. 9, 2017

(30) Foreign Application Priority Data
Jun. 11, 2015 (CN) 201510320322.9

(51) Int. Cl. G06F 3/01; G06F 3/0488

(52) U.S. Cl. CPC G06F 3/018; G06F 3/04886

(57) ABSTRACT

Provided is the Chinese and Japanese Kana Integrated Input Method and Input Method System, comprising: Step A The user first inputs anyone of letter “i, u or v”, following by the roruanized letter corresponding to the kanas, Step B: The IME retrieve and displays the Japanese kana corresponding to the entries at step A in the UI interface; Step C: as one candidate number is displayed at UI interface of step B, and the corresponding numeric key is pressed, the designated Japanese kanas to such numbering are entered; This method will enable input Chinese and Japanese kanas faster and more continuously than prior art.

### FIELD OF INVENTION

The present invention relates to Chinese and Japanese Kana Integrated. Input Method and Input Method System, which is pertain to IME for inputting lingual scripts.

### BACKGROUND ART

In general, there are two kinds of IME for inputting Japanese, one is inputted via roman letter, and another is directly pressing the kana keys. Although Japanese keyboard with kana inscriptions engraved upon its keycaps is available, most people still input Japanese via roman letter, even Japanese who enter Japanese directly by typing kana on the keyboard are far and few between.

There are numerous IMEs such as Sougou, raider and Goole available for the computer and Smart phone users, these IMEs, by their virtual keyboards, are powerful enough to allows the users to enter not only Chinese characters, phrases and symbols but Greece, and Japanese, etc.

In particular to japanese, there are many kanji which are congruent with hattia/Chinese characters and arc recorded into ISO CJK uniform hatizi set of China, Japan and Korea, they could be directly entered according to their Chinese Pinyin pronunciation, in spite of their difference between Japanese and Chinese hanzi.

However, if enterinu the kanas completely incomeruent with hanzi, there is no other but one way to utilize virtual keyboard appendix with an IMF, to those users without Japanese or inputting few kanas, this method is relatively convenient and will not lower efficiencies substantially.

Yet for a text with relatively more kanas to input, this method will reduce efficiencies dramatically, as there needs frequently usinu mouse to activate virtual keyboard for Japanese language, which interrupts typing continuities; especially for the test in Chiriese, it not only requires users to input Chinese and Japanese in alternation, but also they should have basic knowledge of Japanese and the pronunciation of kana ineltrdme hiragana, katakana, “muddied” soundsidaku-on and “half-muddied”/handaku-on, which plumbs the efficiencies to rock bottom.

Currently, there are a few of Chinese phonetic IMEs, which directly load kanas into their Chinese dictionary data according to their Japanese romanized pronunciations; as soon as these romanized letters are typed, the corresponding Japanese kana will be displayed in the input interface, which bring some benefits to the users but simultaneously negative effects of unnecessary interference therewith, because over 80% romanized pronunciations of kanas are identical to the Chinese pinyin, take inputting “ka” in the interface, for instance, the interface will displaying as below:

[symbol]

[symbol]

[symbol]

[symbol]

[symbol]

[symbol]

[symbol]

[symbol]

Obviously, except few options (only 2/8) are available for inputting kanas, the reminders (Chinese hanzi) will distract user's choice; therefore the efficiency of this IME still remains poor likewise. Unless the user could input kanas directly and homogenously via Japanese IME of Micrcisoft, which is curly suitable to the user for uniform inputting Japanese kanas, and is extremely mumbo-jumbo for those who often swap the IME tor integrated inputting Chinese and Japanese at once.

### SUMMARY OF THE INVENTION

Therefore, to the drawbacks of the prior art for integrated inputting Chinese and Japanese kanas synchronously; there needs users more often than not to activate the virtual keyboard or alter IME modes, which disrupt typing coritinuities, and if japanese kanas are loaded into the Chinese dieticmary data of Pinyin IME, to which, myriad Chinese hanzi or phrases with homophonic codes will produce, distracting the user's options and reducing type speed.

In the present in the Chinese and Japanese Kana Integrated Input Method and Input Method. System is provided with the Pinyin phonic method for Chinese-inputting, which comprises:
Step A: anyone of letter “i,u or v” is first inputted , following by the romanized letters, to which their Japanese kanas are designated;
Step B: the IME retrieves and displays the Japanese kanas corresponding to the entries at step A in the UI interface;
Step C: as one numbering for certain candidate is displayed at UI interface of step B, and the corresponding numeric key and confirmed key are pressed, the designated japanese kanas to such nuinbering is entered. Further, the letter pressed by the user at step A is “u” and the confirmed key is the space key respectively. In order to achieve the above-mentioned invention, an integrated IME system for Chinese and Japanese kanas therewith is also provided, which comprises programs for the IME, a dictionary data, encryption algorithm, input interface, said dictionary data includes Chinese Pinyin dictionary data and Japanese kana dictionary data which is lexiconized according to the rule that Japanese kanas are indicated by their romanized letters plus anyone of letter “i, u or v” as their initial.

Further, as received the users' directives, said IMF program retrieves from its dictionary data, and the IME interface will display these Japanese kanas designated by the input directives for user option; the IME program could he implement by computer programs such as C++ or Visual Basic; further, said Japanese kanas include hiragana, katakana, small kana, daku-on and andaku-on.

The integrated IME system for Chinese and Japanese kana in the present invention has beneficial effects, that is, as long as the users possess rudimental knowledge for Japanese language as well as kana pronunciation including hiragana, katakana, daku-on and andaku-on, they could successfully input Chinese and Japanese in succession without disruption or homophonic Chinese .hanzi intervention under the condition of inputting kana, which enable inputting fast and sound, not prone to errors: the more alternation between Chinese and Japanese kanas needs, the more conspicuous the aforesaid advantages manifest.

### BRIEF DESCRIPTION OF ACCOMPANYING DRAWINGS

FIG. 1 shows schematically the interface fbr inputting kanas “ [symbol] ”;

FIG. 2 shows schematically the interface for inputting kanas “ [symbol] ”;

FIG. 3 shows schematically the interface for inputting daku-on “ [symbol] ”;

FIG. 4 shows schematically the interface for inputting andaku-on “ [symbol] ”

### EMBODIMENTS OF INVENTION

The present invention is now described in detail with reference to the following exemplary embodiments.

### EXAMPLE 1

As an integrated IME system for Chinese and Japanese kana in the present invention is installed and activated at the terminals of computer or Snaartphone the user operates according to following steps:

### Step A:

The user first inputs anyone of letter “i ,u or v”, which is corresponding the identical keycap of the keyboard with lowercase locked, as an optimum mode, letter a is initially inputted, for which is much easier touched by the user's index finger, following by the romanized letter a, ha,ba or pa, to which the kanas are designated;

### Step B:

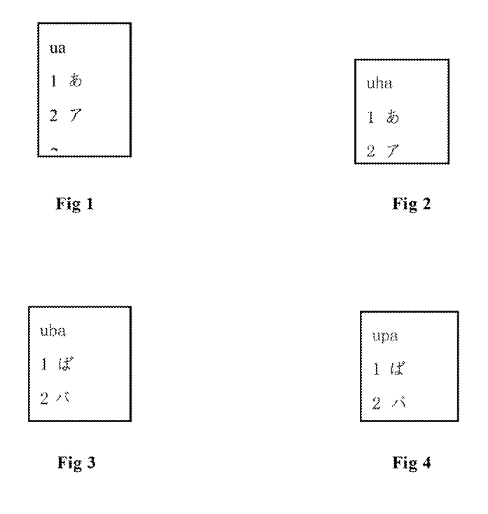

The IME retrieve and displays the Japanese kana corresponding to the entries at step A in the UI interface; FIG. 1 is illustrated as inputting “ua”, FIG. 2 as inputting “idle, FIG. 3 as inputting “uba”, FIG. 4 as inputting “upa”,

Step C: as one candidate number is displayed at UI interface of step B, and the corresponding numeric key is pressed, the designated Japanese kanas to such numbering are entered.

It is clearly illustrated that overall contents displayed in the interface from FIG. 1 to FIG. 4 are Japanese kanas without Chinese hanzi distracting, as result, the user will immediately determine the desired kana(s) without Chinese misinputting.

In order to achieve the above-mentioned invention, it is also provided with an integrated IME system therewith, which comprises programs for the IME, a dictionary data, encryption algorithm, input interface, said dictionary data includes Chinese pinying dictionary data and Japanese kana dictionary data which is lexiconized according to the rule that Japanese kanas are indicated by their romanized letter plus anyone of letter “i,u er v” as their initial.

Taking full advantage of the rule that any letter “i,uor v” is disallowed as the onset of hanzi pinyin this IME of the present invention make it possible that inputting Chinese and japanese kana under single IME condition without interference.

Optimally, as received the users directives, said IME program retrieves from its dictionary data, and the interface of the IME displays these Japanese kanas designated by the input directives for user option. There are two modes for IME to retrieve the dictionary data of the Japanese kana one is normal mode, in which, after the user inputs anyone out of letter “i,u or v”, following by romanized letters corresponding to the Japanese kanas, which, at this moment are accessed by the IME; the continuous inputting mode is that as soon as the user enter anyone of letter “i,u or v, immediately the IME swift to the continuous inputting mode, and at this moment, it will automatically plus one of letter i,u tar v sas the onset of romanized letters entered by the user, and will accordingly retrieve their kanas, what requires the user to do is just entering the romanized letters to their kavas in sequence, the IME will accordingly retrieve these kanas until total entries are finished, and this continuous mode will not retreat until the confirmed key of space bar is pressed.

### EXAMPLE 2

In this specific embodiment of this invention, the user will enter the following contents:

“ [symbol] [symbol] ” (the beautiful sakuru “ [symbol] ” is smiling at me); the first input mode is that the user, via Chinese Pinyin , initially enters “ [symbol] ”, after which, inputs “u” plus romanized letters “sa” with the kana “ [symbol] ” displaying and entering, subsequently inputs “uku” with kana “ [symbol] ” entering and “ula” with kana “ [symbol] ” entering , and finally enters “ [symbol] ” with Pinyin.

If the aforesaid texts arc implemented by shifting IME modes, it will shift twice without continuous inputting; the more alternation between Chinese and Japanese kanas needs, the more conspicuous the aforesaid advantages manifest.

Another alternative inputting mode is that the user lint enters “ [symbol] ” via Chinese pinyin, after which, immediately entering “u” for shifting into the continuous inputting mode, which can be materialized via computer program languages such as C++ or visual Basic; then user input “sa”, and IME will automatically retrieve and display the kana according to “usa” in the dictionary data and enter kana“ [symbol] ”; input “ku” and enter kana “ [symbol] ”, “la” and enter kana “ [symbol] ” on screen; this continuous mode will not retreat until total entries are finished with the space bar pressed for confirmation, and enter “ [symbol] ” with Pinyin finally.

The advantages of this mode is that dictionary data of kanas has remained unchange only by change the program of the IME, one input “u” for one time, in the wake, the romanized letters are inputted directly, which further simplifies the user's inputting and improve on the efficiency

The foregoing description of the preferred embodiments of the present invention has been provided for the purposes of illustration and description. Obviously, many modification and variations will be apparent to personals skilled in the art, which, by using the principle of the present invention described, should also be fallen into the protective scope of the present invention.

1. One Chinese and Japanese Kana Integrated Input Method and Input Method System with the pinyin phonic method for Chinese-inputting, wherein said IME comprise:
Step A: the user first inputs anyone of letter i, u or v in the keyboard, following with roman letters which are designated to their Japanese kana;
Step B: the IME retrieves and displays the Japanese kana corresponding to the entries at step A in the UI interface;
Step C: as one candidate number is displayed at UI interface of step B, the user presses the corresponding numeric key and confirmed key, the designated Japanese kanas to such numbering is entered.

2. The Chinese and Japanese Kana Integrated Input Method and Input Method System of claim 1, wherein said letter pressed by the user at step A is letter u.

3. The Chinese and Japanese Kana Integrated Input Method and Input Method System of claim 1, wherein the confirmed key is the space bar.

4. The Chinese and Japanese Kana Integrated Input Method and Input Method System for achieving claim 1, which comprises the IME programs, a dictionary data, encryption algorithms and an input interface, wherein said dictionary data includes Chinese pinyin dictionary data and Japanese kana dictionary data which is lexiconized according to the rule that Japanese kanas are indicated by their romanized letters plus anyone of letter i,u or v as their initial.

5. The Chinese and Japanese Kana Integrated Input. Method and Input Method System of claim 4, wherein said IME program, as received the user directives, retrieves from its dictionary data, in the IME interface displaying these Japanese kanas designated by the input directives for user option.

6. The Chinese and Japanese Kana Integrated Input Method and Input Method System of claim 5, said Japanese kanas include hiragana, katakana, small kana, daku-on and andaku-on.
